(19) United States
(12) Patent Application Publication
(10) Pub. No.: US 2019/0059397 A1
(43) Pub. Date: Feb. 28, 2019

(54) GLUTEN FREE BREAD PRODUCT WITH AN IMPROVED TEXTURE

(71) Applicant: The Cooking Lab LLC, Tumwater, WA (US)

(72) Inventors: Nathan P. MYHRVOLD, Tumwater, WA (US); Francisco J. MIGOYA, Tumwater, WA (US); Anjana SHANKER, Tumwater, WA (US); Huan Larissa ZHOU, Tumwater, WA (US)

(73) Assignee: The Cooking Lab LLC, Tumwater, WA (US)

(21) Appl. No.: 15/692,551

(22) Filed: Aug. 31, 2017

(51) Int. Cl. A21D 13/066; A21D 2/18

(52) U.S. Cl. CPC A21D 13/066; A21D 2/183; A21D 2/186

(57) ABSTRACT

A gluten free bread product with an improved texture that is prepared using a modified starch and a gluten free flour blend, as well as a method for preparing the improved gluten free bread product. The modified starch may comprise a cooked corn starch slurry or a nixtamalized corn starch.

### BACKGROUND

The present application relates to a gluten free bread product with an improved texture that is prepared using a modified starch and a gluten free flour blend, as well as a method for preparing the improved gluten free bread product. Preferably, the gluten free bread product is a bagel, although the method disclosed herein may be used to form a variety of gluten free bread products, and is not limited to bagels.

The availability of gluten free versions of nearly all food products (including baked goods) has become a necessity in recent years, due to the prevalence of conditions like celiac disease and gluten intolerance, as well as dietary preference. In 2015, for example, the sales of gluten free food products comprised as much as 6.5% of the total sales of all food products. However, for certain food products, providing a gluten free counterpart is not easily achieved. Producing gluten free bread that has an elasticity and structure similar to that of gluten based breads has proven especially difficult for many bakers and manufacturers. This difficulty is especially evident in existing efforts to produce an acceptable gluten free bagel. The bagel is a New York bread staple that is known for having a dense but elastic texture.

In an attempt to replicate the structure and texture of gluten based breads, many bakers have proposed substituting alternative flours, such as rice flour or almond flour. U.S. Published Patent Application No. 2013/0156891, for example, discloses the use of a nixtamalized corn flour with additives. The aforementioned patent application discloses that greater than 60 percent (by weight) of the gluten free flour mixture should be nixtamalized corn flour in order to provide a bread product with superior nutritional properties. In some instances, these alternative flour substitutes may include added agents that help the dough maintain an elastic structure while rising. For example, U.S. Pat. No. 9,049,869 discloses the use of rice flour with the addition of glutathione for improving the fluffiness or softness of the resulting bread product. However, none of these solutions have been successful in providing a gluten free bread product with the taste and texture quality needed to produce a gluten free bagel that resembles a traditional, gluten based bagel.

For example, using a large amount of nixtamalized corn flour (as in U.S. Published Patent Application No. 2013/0156891) can result in a gluten free bread product with inferior taste properties. Similarly, the use of almond flour or rice flour as a wheat flour substitute can result not only in an inferior tasting bread product, but also in a bread product that does not contain material properties sufficient for the preparation of some bakery items. Thus, while it has been known that alternative flours can be a gluten free flour substitute, their uses in certain bread products, such as bagels, was thought to be limited or to produce inferior bread products.

### SUMMARY

The present application discloses a method for preparing a gluten free bread product using a modified starch and a gluten free flour blend, among other ingredients. This combination of ingredients yields dough that can be used to prepare a gluten free bagel having the elasticity and texture of a traditional bagel containing wheat flour, while still maintaining a good taste quality.

According to an exemplary disclosed embodiment, a cooked starch slurry is combined with a gluten free flour blend and other ingredients to form a dough. The cooked starch slurry may, for example, include corn starch and is formed by combining the corn starch with water, and heating the mixture of corn starch and water to a predetermined temperature. Preferably, the predetermined temperature is between 65° and 70° C. The cooked corn starch slurry is then combined with the gluten free flour blend and other additives to form a dough.

In another preferred embodiment, a nixtamalized corn starch is combined with a gluten free flour blend and other ingredients to form a dough. Nixtamalization is the process of preparing corn by soaking the corn, and then cooking it in an alkaline solution (preferably limewater) before hulling the corn. The nixtamalized corn is then ground to form the nixtamalized corn starch. The nixtamalized corn starch is then combined with the gluten free flour blend and other additives to form a dough.

It is to be understood that both the foregoing general description and the following detailed description are exemplary and explanatory only, and are not restrictive of the invention as claimed. In particular, the present application is not limited to modified corn starches, and the improved gluten free bread product can be achieved using many types of modified starches. In addition, the different types of starches may be modified using various methods of modification, and the methods of modification are not limited to only those methods disclosed herein.

### DETAILED DESCRIPTION

While substituting a gluten free starch in bread recipes can replicate some of the effects of a gluten based starch, the simple addition of certain gluten free starches does not typically result in a gluten free bread product with the texture and elasticity needed for certain bread products—for example, bagels. Through experimentation, the inventors in the present application found that modifying gluten free starches according to certain methods yields a gluten free dough with the required texture to prepare baked items that traditionally have a chewiness and elasticity that were previously thought to be unattainable with a gluten free dough.

According to a first embodiment, a first example of a modified gluten free starch is prepared and used to form a dough that will yield a gluten free bread product with an improved texture. The first example of such a modified gluten free starch is a cooked corn starch slurry that is formed by first combining corn starch with water. Specifically, corn starch and water are mixed to hydrate the corn starch. After mixing, the hydrated corn starch is heated (i.e., cooked) at a predetermined temperature. Preferably, the hydrated corn starch is heated to a predetermined temperature of between 65° C. and 70° C. Once the hydrated corn starch reaches the predetermined temperature, the mixture is removed from heat and stirred until the heated corn starch is smooth in consistency. The corn starch is then cooled to form the slurry, which is now a modified form of corn starch. Preferably, the cooked corn starch slurry is cooled to a room temperature.

In order to produce a gluten free bread product using the corn starch slurry (preferably a bagel), the cooked corn starch slurry and additional ingredients are combined and processed according to the following steps. First, water and a leavening agent, preferably yeast, are combined and mixed to dissolve the leavening agent. Next, the cooked corn starch slurry, gluten free flour blend, sweetener, oil, salt and malt syrup are then added to the water and yeast mixture to form a dough. Preferably the sweetener is sugar, and the oil is vegetable oil. The dough is then mixed with a paddle for 3 to 5 minutes until smooth. The dough is then transferred to a lightly oiled container and covered with a lid for about one hour. Finally, the dough is divided into balls. Preferably, the dough is divided into balls weighing about 200 g each. The shaped dough balls are then proofed on covered baking sheets for about 45 minutes. After proofing, the shaped dough balls are boiled in a solution containing water and lye. Preferably, the shaped dough balls are boiled for a total of one minute, about 30 seconds on each side. Finally, the boiled dough balls are baked at a preferred temperature, depending upon the type of oven used. The final product is a gluten free bagel with good taste and texture resembling that of a traditional, gluten based bagel, to which additional flavors can be added.

The gluten free bagel containing the cooked corn starch slurry may be prepared by combining the ingredients according to the measurements provided in Table 1 below, although one skilled in the art will recognize that the measurements used to form the gluten free bagel may vary, and are not limited to those specifically described herein. One skilled in the art will also recognize that other oils, sweeteners and leavening agents may be employed to produce a dough for a gluten free bagel, and that the additives are not limited to those specifically described herein.

TABLE 1

| | | |
|---|---|---|
| INGREDIENTS | WEIGHT | BAKERS % |

For Corn Starch Slurry

| | | |
|---|---|---|
| Corn Starch | 94 | 15% (total weight of the flour) |
| Water | 364 | 58% (total weight of the flour) |

For the Dough

| | | |
|---|---|---|
| Water | 134 g | 70 |
| Instant Yeast | 1.50 g | 0.24 |
| Gluten Free Flour Blend | 625 g | 100 |
| Corn Starch Slurry (from | 458 g | (Starch 94 + Water 364 = 458) |
| above) | | 73.28% |
| Sugar | 25 g | 4 |
| Vegetable Oil | 17 g | 2.72 |
| Malt Syrup | 12 g | 1.92 |
| Fine Salt | 13 g | 2.08 |

For the Lye Solution

| | | |
|---|---|---|
| Water | 4 Kg | 100 |
| Lye | 6 g | 0.15 |

In the gluten free bread dough of the present application, the ratio for mixing corn starch to water to form the cooked corn starch slurry may be determined in accordance with a general amount that may be employed when making gluten free breads using a modified corn starch. Preferably, however, the amount of water is about 58% of the amount of gluten free flour blend added by mass, as shown in Table 2 above. Preferably, the amount of corn starch is about 15% of the amount of gluten free flour blend added by mass, as also shown in Table 2 above.

According to a second exemplary embodiment, another example of a modified starch is prepared and used to form a dough that will yield a gluten free bread product with an improved texture. In the second embodiment, a nixtamalized corn starch is combined with a gluten free flour blend and other additives to form the dough. During experimentation, it was found by the inventors of the present application that adding a specific, small amount of nixtamalized corn flour to gluten containing dough increased the chewiness and elasticity of the dough. This is likely a result of zein, a gluten-like protein that is found in corn. Isolating zein has not been found to be effective for use in most dough applications, due to its unappealing taste. However, it was discovered through this experimentation that adding small amounts of nixtamalized corn flour to gluten free dough replicates some of the effects of zein, while still maintaining good taste quality.

In view of the above gluten based bagel experiment, a specific ratio of nixtamalized corn flour was added to a gluten free flour blend to form a dough. Specifically, the amount of nixtamalized corn flour is about 15% to 20% of the amount of gluten free flour blend by mass. Preferably, the amount of nixtamalized corn flour is 15% of the amount of gluten free flour blend by mass, which yields not only an appropriate texture for producing a gluten free bagel, but also the best taste quality.

Thus, in order to prepare the gluten free bread product with an improved texture, a nixtamalized corn starch is first prepared. As noted above, the process of nixtamalization is performed by soaking corn in water, and then cooking the corn in an alkaline solution. Preferably, the alkaline solution is limewater. The corn is hulled, and then ground to form the nixtamalized corn starch. The nixtamalized corn starch is then combined with a gluten free flour blend and other additives. Specifically, in order to produce a gluten free bagel with an improved texture, the ingredients are combined and processed according to the following steps. First, water and the leavening agent, preferably yeast, are combined to dissolve the leavening agent. The nixtamalized corn starch, gluten free flour blend, sweetener, oil, salt and malt syrup are then added to the water and yeast mixture to form a dough. Preferably the sweetener is sugar, and the oil is vegetable oil. The dough is then transferred and covered for about one hour. The dough is then divided into balls preferably weighing about 200 g, and shaped into bagel shapes. The shaped dough balls are then cold-proofed for a predetermined amount of time, preferably 12 to 15 hours. After cold-proofing, the shaped dough balls are boiled in a solution containing water and lye. Preferably, the shaped dough balls are boiled for a total of one minute (about 30 seconds on each side). Finally, the boiled dough balls are baked at a preferred temperature, depending upon the type of oven used. The temperatures used for cooking will vary depending upon the type of oven. The final product is a gluten free bagel with good taste and texture, to which additional flavors can be added.

The gluten free bagel containing the nixtamalized corn starch may be prepared by combining the ingredients according to the measurements provided in Table 2 below, although one skilled in the art will recognize that the measurements used to form the gluten free bagel may vary, and are not limited to those specifically described herein. One skilled in the art will also recognize that other oils, sweeteners and leavening agents may be employed to produce a dough for a gluten free bagel, and that the additives are not limited to those specifically described herein.

TABLE 2

| | | |
|---|---|---|
| INGREDIENTS | WEIGHT | BAKERS % |

For the Dough

| | | |
|---|---|---|
| Water | 437.50 g | 70 |
| Instant Yeast | 1.50 g | 0.24 |
| Gluten Free Flour Blend | 625 g | 100 |
| Nixtamalized Corn Starch | 93.75 g | 15 |
| Sugar | 25 g | 4 |
| Vegetable Oil | 17 g | 2.72 |
| Malt Syrup | 12 g | 1.92 |
| Fine Salt | 13 g | 2.08 |

The gluten free flour blend used to prepare the gluten free dough disclosed in the above two embodiments may be prepared by combining ingredients that include, but are not limited to, white rice flour, brown rice flour, glutinous rice flour, cornstarch, tapioca starch, nonfat milk powder, xanthan gum, and transglutaminase. A method for preparing the gluten free flour blend is by whisking all the ingredients together, transferring the mixed ingredients to a food processor and processing until finely ground, and sifting the processed ingredients to form the gluten free flour blend. The gluten free flour blend may be prepared by combining the ingredients according to the measurements provided in Table 3 below, although one skilled in the art will recognize that both the measurements and ingredients used to form the gluten free flour blend may vary, and are not limited to those specifically described herein.

TABLE 3

| INGREDIENTS | WEIGHT | VOLUME | | [symbol] |
|---|---|---|---|---|
| White rice flour | 450 g | 4 | cups | 23.2 |
| Brown rice flour | 200 g | 1¼ | cups | 10.31 |
| Glutinous rice flour | 140 g | 1¼ | cups | 7.22 |
| Cornstarch | 700 g | 6 | cups | 36.08 |
| Tapioca starch | 450 g | 3¾ | cups | 23.2 |
| Nonfat milk powder | 200 g | 3⅓ | cups | 10.31 |
| Xanthan gum | 20 g | 2 | Tbsp | 1.03 |
| Transglutaminase | 19.4 g | 2 | Tbsp | 1 |
| TI or WM (optional) | | | | |
| Yield | ~2.16 kg | | | |

While various embodiments have been described above, it should be understood that they have been presented by way of example only, and not of limitation. For example, while the present application discloses the preparation of a gluten free bagel, one skilled in the art would understand that the dough mixture may be used for other gluten free bread making purposes, and should not be limited only to the uses described herein. Additionally, substitutions and variations of ingredients may be made for other ingredients with equivalent function, and thus, within the scope of the claims, such substitutions and variations are included without departing from the spirit of the invention.

Although the current disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

What is claimed is:

1. A gluten free bread product having an improved texture, the gluten free bread product comprising a modified gluten free starch and a gluten free flour blend.

2. The gluten free bread product according to claim 1, wherein the modified gluten free starch is a cooked slurry comprising a gluten free starch and water.

3. The gluten free breach product according to claim 2, wherein the gluten free starch comprises corn starch.

4. The gluten free bread product according to claim 3, wherein the cooked corn starch slurry contains water in an amount of about 58% of the amount of gluten free flour blend added by mass.

5. The gluten free bread product according to claim 3, wherein the cooked corn starch slurry contains corn starch in an amount of about 15% of the amount of gluten free flour blend added by mass.

6. The gluten free bread product according to claim 1, wherein the modified gluten free starch is a gluten free starch that has been heated with water to a predetermined temperature to form a slurry.

7. The gluten free bread product according to claim 6, wherein the predetermined temperature is between 65° and 70° C.

8. The gluten free bread product according to claim 1, wherein the modified starch is a nixtamalized corn starch.

9. The gluten free bread product according to claim 8, wherein the gluten free product contains nixtamalized corn starch in an amount of about 15% of the amount of gluten free flour blend added by mass.

10. The gluten free bread product according to claim 1, wherein the gluten free flour blend comprises at least one of white rice flour, brown rice flour, glutinous rice flour, cornstarch, tapioca starch, nonfat milk powder, xanthan gum, and transglutaminase.

11. The gluten free bread product according to claim 1, further comprising at least one of a sweetener, a salt, and a leavening agent.

12. The gluten free bread product according to claim 11, wherein the sweetener is sugar and the leavening agent is yeast.

13. The gluten free bread product according to claim 1, further comprising an oil, a salt, and a malt syrup.

14. A gluten free bagel comprising a modified starch and a gluten free flour blend, wherein the modified starch is a cooked slurry including a gluten free starch and water.

15. The gluten free bagel of claim 14, wherein the gluten free starch is corn starch and the cooked starch slurry contains water in an amount of about 58% of the amount of gluten free flour blend added by mass.

16. The gluten free bagel of claim 14, wherein the gluten free starch is corn starch and wherein the cooked corn starch slurry contains corn starch in an amount of about 15% of the amount of gluten free flour blend added by mass.

17. A method for producing a gluten free bagel with an improved texture, the method comprising:
mixing a modified starch with a gluten free flour blend and additives to form a dough;
allowing the dough to ferment;
dividing the dough into dough balls weighing a predetermined amount;
shaping each of the dough balls into a bagel shape;
proofing the dough balls;
boiling the dough balls in a solution containing water and lye; and
baking the dough balls at a predetermined temperature to produce a gluten free bagel.

18. The method of claim 17, wherein the additives comprise at least one of water and a leavening agent.

19. The method of claim 18, wherein the additives further comprise at least one of a sweetener, an oil, and a salt.

20. The method of claim 17, wherein the leavening agent is yeast.

21. The method of claim 17, wherein the dough is divided into balls weighing 200 g.

22. The method of claim 17, further comprising the steps of:
combining a starch with water to hydrate the starch;
heating the hydrated starch to a temperature of between 65° and 70° C. to form a slurry; and
cooling the slurry to form the modified starch.

23. The method of claim 17, further comprising the steps of:
nixtamalizing corn; and
grinding the nixtamalized corn to form the modified starch.
